(19) United States
(12) Patent Application Publication
(10) Pub. No.: US 2026/0362027 A1
(43) Pub. Date: Nov. 12, 2026

(54) METHODS AND TECHNIQUES FOR IMAGE SENSING

(71) Applicant: Hussein Ali, Foothill Ranch, CA (US)

(72) Inventor: Hussein Ali, Foothill Ranch, CA (US)

(21) Appl. No.: 19/465,506

(22) Filed: Jan. 30, 2026

Related U.S. Application Data
(60) Provisional application No. 63/800,640, filed on May 6, 2025.

(51) Int. Cl. H04N 25/47; H04N 23/68; H04N 25/766; H04N 25/773; H04N 25/78

(52) U.S. Cl. CPC H04N 25/47; H04N 23/6812; H04N 25/766; H04N 25/773; H04N 25/78

(57) ABSTRACT

Event based sensors generate output only when a change in the scene occurs, unlike frame-based imagers that produce a constant stream of data regardless of the scene dynamics. This technique offers benefits like improved high-speed visual acquisition, low power consumption, and higher dynamic range performance. The proposed circuits achieve lower power consumption, higher dynamic image quality, and better image linearity compared to conventional methods.

### RELATED APPLICATIONS

This application claims the priority of U.S. Provisional Application No. 63/800,640, entitled “METHODS AND TECHNIQUES FOR IMAGE SENSING” filed on May 6, 2025, the disclosure of which is hereby incorporated by reference in its entirety.

### BACKGROUND OF THE INVENTION

DVS pixel responds to changes in the scene, and outputs only two bits for event status and event polarity. Illustrated in FIG. 1, the pixel front-end has the Photodiode “PD”, which is configured to generate a logarithmic voltage, v_log, proportional to the change in the PD current, which corresponds to a change in the scene illumination level. This voltage is then amplified by a gain stage, “A”, and the output is compared to two thresholds, +vth and −vth, to determine the change polarity. The DVS pixel operation is locally autonomous, continuously monitoring the photodiode current change, and takes the event decision based on the corresponding logarithmic voltage, v_log, when compared to the preset threshold voltages. The global sampling signal, GSYNC, stores the event status at a certain instance of time, and the RS signal checks the corresponding two bits, event_flag and event_polarity, for event status and event polarity, respectively. The RS readout these bits to the periphery. EXT_RST signal forces reset in the pixel, if the pixel didn't register an event for long time. This long time is determined based on the amount of leakage, and/or the low frequency noise.

Three challenges in the DVS pixel operation that need to be addressed. First, the pixel has a static current that scales with the background illumination. In the case of a bright scene with no activity, the static power of the sensor could be high, especially for large pixel arrays in high resolution imagers. Second, the DVS pixel usually registers the event variation when it exceeds a specific threshold, so the information of the magnitude of this change is not complete, missing or minimal. The knowledge of the intensity change magnitude would facilitate the post-processing algorithms and is useful in the image reconstruction. Third, when the pixel registers an event, the corresponding bits will readout, and the pixel will reset. During this reset time, the pixel is idle, and it can't track the variation in the PD current. This idle time is called the pixel refractory period, and it may cause non-linearity in the DVS output versus input signal in the time domain. In fully autonomous readout, this refractory period might be useful to prevent specific pixels from blocking the readout. In the case where the readout is done by checking the pixels'event status, this Pixel-On-Demand readout doesn't benefit from the refractory period, and so it represents a non-linear deadtime that varies among the pixels in the array. The following methods and techniques solve for these three challenges.

### SUMMARY OF THE INVENTION

To save power, an imaging mode can be introduced to skip the read or the status checking of some or all of the DVS pixels. The skipped pixels are then forced into a low-power standby status, by bringing down the PD current to zero, or near zero. This can be done by cutting the current path, as in FIG. 2 pixel disable block. This is also can be done in another way, by forcing v_log into a voltage that disable the PD current path, for example, if v_log is forced to zero volt, the transistor above the PD is in cut-off mode, and the current path is zero. All the previous combined represents a novel way to reduce the power consumption in a DVS pixel array. A second novelty is a technique to provide more scene information from the DVS pixel, where the v_log can be buffered and converted into digital bits, by quantizing the analog v_log voltage using multi-bit quantizer. This can be done in a separate conversion path from the event detection path, as shown in FIG. 3, or can be combined with the event detection path. A third novelty is a technique to minimize or remove the refractory period, where the DVS pixel is in reset mode after registering an event. This refractory period is a DVS deadtime, where it can't detect events. By introducing two paths for the reset and event detection in the DVS pixel, as illustrated in FIG. 4, where detection and reset functions alternate in a ping-pong fashion, the refractory period is removed.

An image sensing device of the described innovations may include a digital retina pixel circuit equipped with a photodiode converting a plurality of light signals into a logarithmic voltage signal and an amplifier amplifying the logarithmic voltage signal for processing at a dual comparator stage. The dual comparator stage may include a first positive comparator and a second negative comparator wherein the first positive comparator compares the amplified logarithmic voltage to a positive threshold value and the second negative comparator compares the amplified logarithmic voltage to a negative threshold value. The image sensing device may further include an output and reset logic stage receiving a positive comparator output and a negative comparator output from the dual comparator stage, the output and reset logic stage generating an event variable. In one embodiment, the device includes a readout block generating an event output based on the generated event variable.

The image sensing device may also include a pixel disable block deactivating the current paths for the photodiode in the digital retina pixel circuit. In one implementation, the device includes an array of digital retina pixel circuits configured in a set of columns and a set of rows. In this instance, the pixel disable block may be configured to deactivate a column in the array of digital retina pixel circuits. In other instances, the pixel disable block is configured to deactivate a row in the array of digital retina pixel circuits. The pixel disable block may also be configured to deactivate a region of interest in the array of digital retina pixel circuits.

The image sensing device may further include an inertial measurement unit capable of measuring inertial measurement data. The inertial measurement unit may be composed of a plurality of accelerometers and a plurality of gyroscopes. In one embodiment, the device may also comprise an active pixel sensor including a first digital retina pixel circuit, a dynamic vision sensor equipped with a second digital retina pixel circuit including a photodiode converting a plurality of light signals into a logarithmic voltage signal and an amplifier amplifying the logarithmic voltage signal for processing at a dual comparator stage. The dual comparator stage may include a first positive comparator and a second negative comparator wherein the first positive comparator compares the amplified logarithmic voltage to a positive threshold value, and the second negative comparator compares the amplified logarithmic voltage to a negative threshold value. The device may also include an output and reset logic stage receiving a positive comparator output and a negative comparator output from the dual comparator stage, the output and reset logic stage generating an event variable. In one implementation, a readout block generates an event output based on the generated event variable.

The image sensing device may comprise a voltage copier buffering the logarithmic voltage signal, a sampling capacitor receiving a sampled signal based on the buffered logarithmic voltage signal from the voltage copier and an analog-to-digital converter converting the sampled signal into a digital signal. The device may further comprise an array of active pixel sensors and an array of dynamic vision sensors, the array of active pixel sensors and the array of dynamic vision sensors arranged in a plurality of rows and a plurality of columns. In one embodiment, a plurality of analog-to-digital converters are associated with each one of the active pixel sensors in the array of active pixel sensors. The plurality of analog-to-digital converters may also be associated with each column in the plurality of columns arranged with the array of active pixel sensors.

The analog-to-digital converter may generate a multi-bit quantization and a digital signal representation of a magnitude of scene dynamic changes and a corresponding absolute magnitude of a scene brightness and a background light level. In one implementation, the output and reset logic stage may be synchronized with the multi-bit quantization and the digital signal representation of the magnitude of scene dynamic changes and the corresponding absolute magnitude of the scene brightness and the background light level.

An image sensing device may include a dynamic vision sensor equipped with a first digital retina pixel circuit including a photodiode converting a plurality of light signals into a logarithmic voltage signal. The device may also include an amplifier, an output and reset logic stage, a readout block and a reset logic block. The amplifier may amplify the logarithmic voltage signal for processing at a dual comparator stage. The dual comparator stage may include a first positive comparator and a second negative comparator wherein the first positive comparator compares the amplified logarithmic voltage to a positive threshold value, and the second negative comparator compares the amplified logarithmic voltage to a negative threshold value. The output and reset logic stage may receive a positive comparator output and a negative comparator output from the dual comparator stage, the output and reset logic stage generating an event variable. The readout block may generate an event output based on the generated event variable. The reset logic block may process the event variable and the event output from the output and reset logic stage and the readout block respectively.

In one embodiment, the image sensing device may further comprise a reset ping pong stage in communication with the reset logic stage. The reset ping pong stage may include a first reset path and a second reset path. In one implementation, the first reset path is initially configured to detect current changes in the photodiode, and the second reset path is initially configured in a reset mode. The reset logic may alternate configurations of the first reset path and the second reset path based on the event variable and the event output from the output and reset logic stage and the readout block respectively. The image sensing device may include a dual comparator stage which includes a first dual comparator stage in communication with the first reset path and a second dual comparator stage in communication with the second reset path.

### BRIEF DESCRIPTION OF THE FIGURES

FIG. 1 illustrates a circuit diagram of a dynamic vision sensor pixel.

FIG. 2 illustrates a circuit diagram of a dynamic vision sensor pixel-disable by current-cut.

FIG. 3 illustrates a circuit diagram of integration based sensing in a dynamic vision sensor pixel.

FIG. 4 illustrates a circuit diagram of a ping-pong reset in a dynamic vision sensor pixel.

FIG. 4b illustrates a circuit diagram of a ping-pong reset in a dynamic vision sensor pixel.

FIG. 5 illustrates a flow chart of ping-pong reset logic in a dynamic vision sensor pixel.

FIG. 6 illustrates a schematic diagram of a vision sensor system according to one embodiment.

### DETAILED DESCRIPTION OF THE INVENTION

The present invention is described in the following examples, which are set forth to aid in the understanding of the invention and should not be construed to limit in any way the scope of the invention as defined in the claims which follow thereafter.

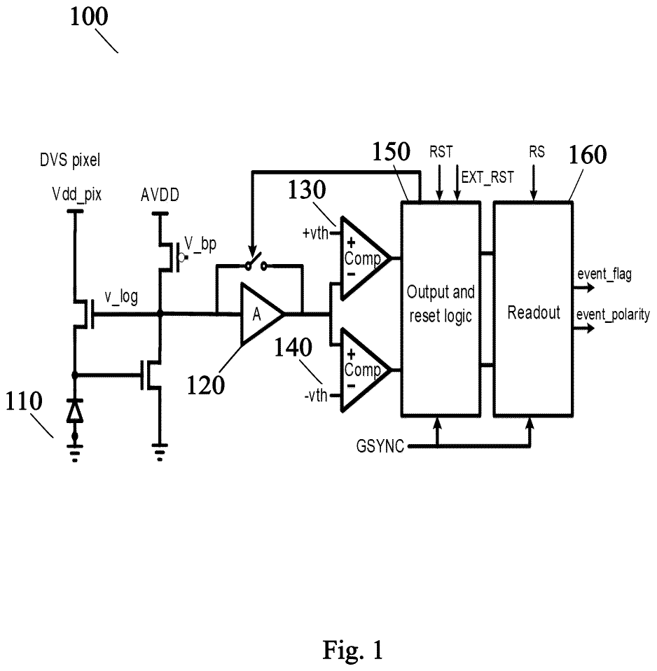

FIG. 1 illustrates a circuit diagram of a dynamic vision sensor pixel. FIG. 1 shows a simplified circuit 100 for the DVS pixel, where the photodiode(“PD”) 110 may be configured in a feedback to have logarithmic voltage, v_log, which is amplified by a gain 120, A, and the resulting output is compared with two thresholds, +vth 130 and −vth 140. Other embodiments may include an open loop without feedback. The output and reset logic 150 detect if there is an event and decides if it is a positive or negative event, then resets the amplifier. The readout 160 is transferring the event data to the periphery for post-processing. The GSYNC signal registers the DVS pixels'status in the pixel array, by controlling the reset and readout logic.

A pixel may refer to a sensing element which converts light photons into electrical charges, proportional to the intensity of light impinging on it; pixel circuit or pixel electronics refers to the electronic components and circuitry of the pixel. Accordingly, a pixel circuit will be used in the context of electronics of the pixel, and the term “pixel” will be used to refer to the sensing element as a whole. Typically, a sensor will be made up of a two-dimensional array of pixels and additional peripheral circuitry. Nevertheless, a two dimensional array is not required for all applications. A sensor can also contain a single pixel (array of one pixel) or a one-dimensional array (line sensor) of pixels.

A dynamic vision sensor or neuromorphic/event-based vision camera may be configured for real-time sensing in robotics, drone applications, machine vision, autonomous systems, and embedded applications. The dynamic vision sensor may include a 65 nm back-side illuminated (BSI) CMOS image sensor, which allows it to detect changes in brightness asynchronously with very low latency. In some implementations, the sensor may range from 180 nm to 45 nm or smaller. As noted above, the dynamic vision sensor outputs events instead of full frame images. According to one embodiment, the resolution of the sensor may be 1280×960 pixels, each capable of independently reporting changes in scene contrast. Other sensor resolutions ranging from hundreds of pixels to hundreds or thousands of megapixels may also be utilized here. The temporal resolution of the sensor may be 100 μs, providing high temporal precision with latencies under 1 millisecond, allowing downstream systems to respond quickly to changes in the scene. The dynamic vision sensor event throughput could be higher than 165 million events per second (MEPS), and it provides a wide dynamic range, roughly 120 dB or higher. The DVS sensor may be further equipped with an Inertial Measurement Unit ‘IMU, e.g. a gyroscope and an accelerometer for measuring inertia and sensor movements.

An IMU may be configured to operate in conjunction with an image sensor to support motion estimation, stabilization, and time-correlated sensing. In one implementation, the IMU includes a plurality of inertial sensors rigidly coupled to a common body frame and mechanically aligned with a reference frame of the image sensor. For example, the IMU may include three accelerometers configured to measure specific force components and three gyroscopes configured to measure angular rate components along orthogonal axes. In some implementations, a magnetometer or additional environmental sensors may also be included.

During operation, the IMU generates inertial measurement data that may be temporally synchronized with image sensor output. The accelerometers produce signals indicative of linear acceleration, including gravitational components, while the gyroscopes produce signals indicative of angular motion of the image sensor about the respective axes. The IMU is configured to provide high-rate, low-latency inertial data relative to the image frame rate, enabling interpolation of sensor motion between successive image frames.

In some embodiments, inertial data may be processed to compensate for bias, scale factor error, misalignment between the IMU and image sensor coordinate frames, and temperature-dependent variations. The IMU outputs motion estimates that are fused with image-derived measurements to support visual-inertial processing, including image stabilization, motion blur compensation, rolling-shutter correction, and visual-inertial odometry. The IMU may provide calibrated and time-aligned inertial measurements to the image sensor or an associated processor, enabling accurate correlation between captured image data and sensor motion. By tightly coupling inertial and visual information, the IMU enhances spatial and temporal coherence of the image data and supports downstream applications such as camera pose estimation, three-dimensional reconstruction, and navigation.

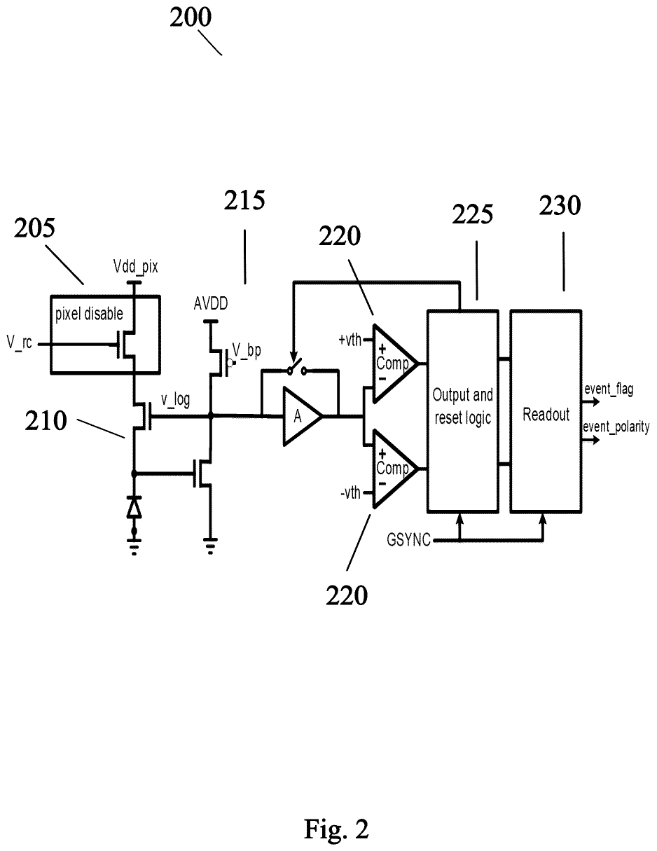

FIG. 2 illustrates a circuit diagram of a dynamic vision sensor pixel-disable by current-cut. The Pixel Circuit (left side) 205 includes supply/control voltages denoted as, V_dd_pix and V_rc. Additionally, the pixel circuit includes a pixel disable block which may allow selective enabling/disabling of pixels. In one embodiment, the pixel-disable block may selectively turn off individual pixels, so they stop generating events. This may be implemented at the pixel level, column level, row level as a gating mechanism to reduce power consumption, reduce noise, and minimize the sensor data deluge. To accomplish this, the pixel disable circuit may turn off the corresponding pixel's—row's or column's—comparator(s) and output circuitry(ies). This technique may block hot or noisy pixels. Hot pixels may include pixels that continuously fire. Noisy pixels include over reporting of events due to leakage or mismatch. By disabling pixels/rows/columns, the sensor can reduce bandwidth and event clutter. This may also reduce downstream event load, decrease in power consumption and improvement of the signal to noise ratio for event-based algorithms. The pixel disable functionality may also permit the implementation of a region of interest mode by establishing a programmable region of interest and turning off those pixels outside of the region of interest.

Below the pixel circuit is a transistor stack 210 which is part of a phototransistor-based circuit that converts incoming light into a voltage signal (V_log). According to one embodiment, the two transistors to ground are components of a biasing or clamping circuit for signal conditioning.

FIG. 2 further illustrates an amplifier stage 215 which may buffer or amplify a signal (V_log) to produce an amplified output, the amplified output may then be used for processing. The V_bp voltage may be used for biasing or clamping for signal conditioning. In one embodiment, two comparators 220 compare the amplified output against +Vth (positive threshold)−Vth (negative threshold). These help detect changes in light intensity (positive or negative events). Output and reset logic 225 may decide if an event (change in intensity) has occurred based on comparator outputs. GSYNC (Global Synchronization) may provide a timing signal to synchronize output/reset across the array. The readout block 230 (Rightmost) may generates event_flag, which indicates an event occurred and event_polarity which indicates whether it was a brightening (+) or darkening (−) event.

When there is no activity in the scene or the Region-Of-Interest, “ROI”, part of the pixel array can be in power down mode, either through skipping rows in the readout, or skipping columns, or both. FIG. 2 shows how to save power in these skipped pixels, by cutting the current path in the PD through a pixel disable block. One way to do this is by having a transistor that could be turned off by its gate voltage, V_rc. The static power that scales with the scene brightness is now saved, which at high illumination could save most of the power consumed by the DVS sensor. Another way to cut the PD current is by forcing v_log voltage to a state which makes the transistor stack 210 in an off-state. z

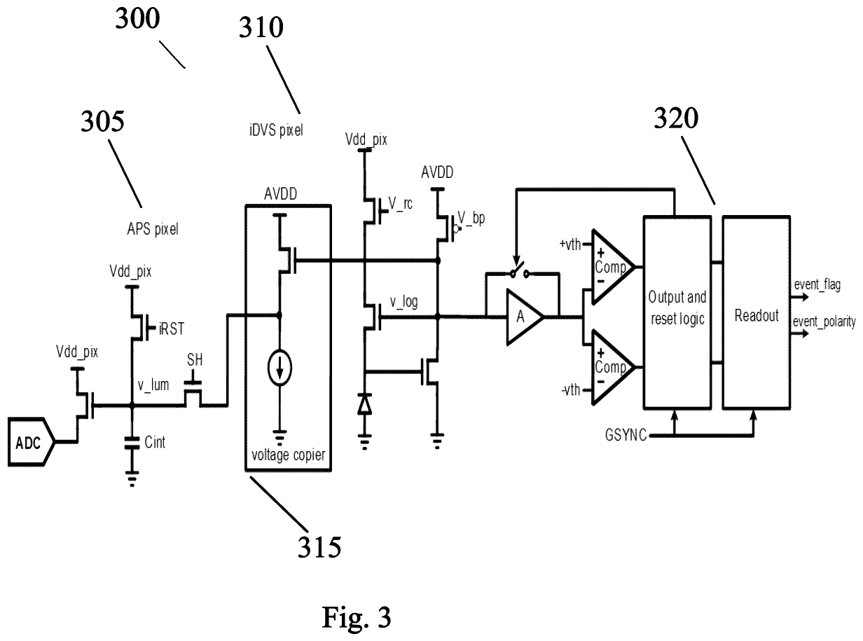

FIG. 3 illustrates a circuit diagram of integration based sensing in a dynamic vision sensor pixel. The circuit diagram depicted in FIG. 3 is a hybrid intensity-change-magnitude Active Pixel Sensor (APS) 305 and Dynamic Vision Sensor (DVS) pixel 310 architecture. It combines both frame-based (APS) and event-based (DVS) readouts, allowing more flexible and efficient vision sensing. The core components include an APS pixel 305, a DVS Pixel 310, a voltage copier 315, event processing and readout block 320. All these components constitute the integration and Dynamic Vision Sensor pixel ‘iDVS’.

An APS pixel 305 may include an interface circuit, like a buffer or gain stage, to copy the logarithmic voltage of the DVS pixel, v_log, may include a sampling circuit that prepares a sampled logarithmic voltage to be quantized by the Analog-to-Digital-Converter ‘ADC’, a circuit that provides a reference for the logarithmic voltage conversion from analog to digital, for example, this reference could be used to perform Correlated Double Sampling ‘CDS’. CDS is a signal processing technique that takes two sequential samples of a sensor's output—one for the reference/reset level and one for the actual signal—then subtracts them to cancel out fixed errors like DC offsets, 1/f (flicker) noise, and kTC noise. The APS pixel may also include a final buffer stage and an ADC. This ADC can be per pixel, or per column of pixels.

In one embodiment, the APS may include pixel sizes from 0.5 μm-50 μm which when on the larger side permit the pixel to capture usable data even under very low illumination conditions, giving it an advantage in environments where light is limited. In one embodiment, the APS pixel may be implemented in a variety of array sizes. For example, the array size may be 128×128, 240×180, 320×240, 346×260, 640×480, and or 1280×720. Other array sizes may include up to 8000×6000 or (48MP). The APS may include a built-in timing generator, bias generator, A/D converter, and SPI (serial peripheral interface) allow the device to be controlled digitally and operated with minimal external components.

The voltage copier 315 may include an analog circuit inside an image sensor pixel that can function to buffer, sample, store, reproduce a voltage level with high fidelity. In a hybrid APS and DVS pixel, a voltage copier allows the same photodiode to support two different readout modes, APS mode and DVS mode. APS mode samples an absolute intensity level and DVS mode may detect changes in relative intensity over time. In one embodiment, the DVS pixel may compare the current photodiode voltage versus the previous photodiode voltage to detect a log intensity change. The voltage copier may provide the mechanism to store the previous voltage by sampling the photodiode, copying the voltage onto an integration or sampling capacitor and holding it as a reference for the next event comparison. This provides information of the event magnitude for events detected by the DVS comparator which registers the on/off event generation. Additionally, the voltage copier may permit APS signal path and DVS signal path isolation. In other words, the voltage copier may capture the APS voltage without forcing the DVS comparator to track it and copies the DVS logarithmic voltage without affecting the APS integration node by creating an electrical separation between the two signal paths.

FIG. 3 further illustrates the iDVS pixel concept, which consists of the DVS pixel, and a circuit to quantize the intensity change magnitude. The logarithmic voltage, v_log, which corresponds to the PD current variation, is buffered through a voltage copier 315, which is then sampled by the signal SH, onto a sampling capacitor, Cint. The iRST signal provides a reference level for each pixel to minimize fixed pattern noise. The Sampled voltage is then converted into digital by the Analog-to-Digital-Converter, “ADC”, which provides multi-bit quantization of the intensity change, synchronized with the DVS event detection circuitry. This ADC operation can be done at the periphery, to save area in the pixel array for the DVS function. The sampling time on Cint, through SH signal, could be determined by the reset and the event_flag, such that the sampling time on Cint starts when the reset of the DVS circuit ends, and the sampling time on Cint ends when event_flag registers an event.

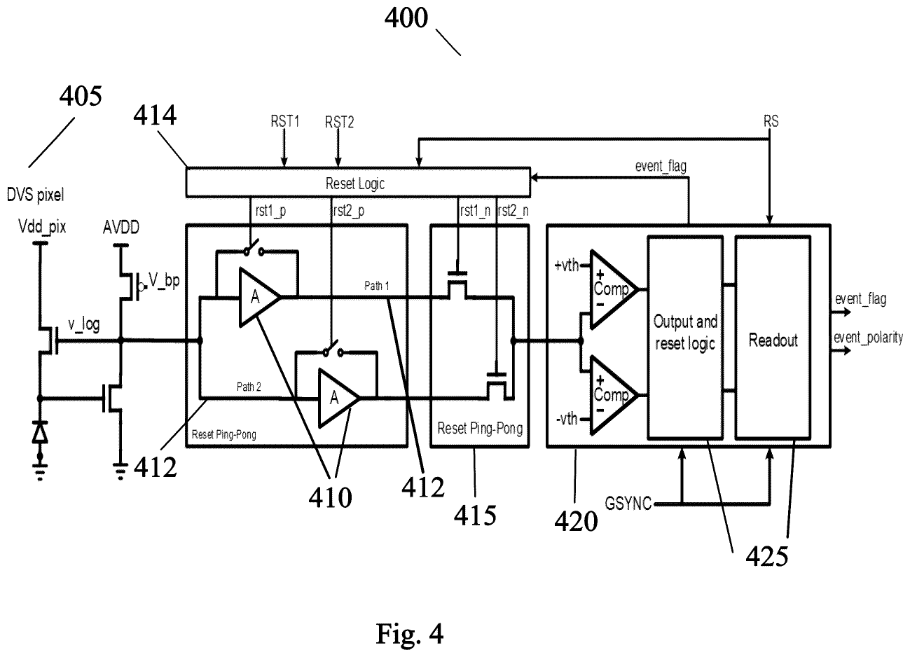

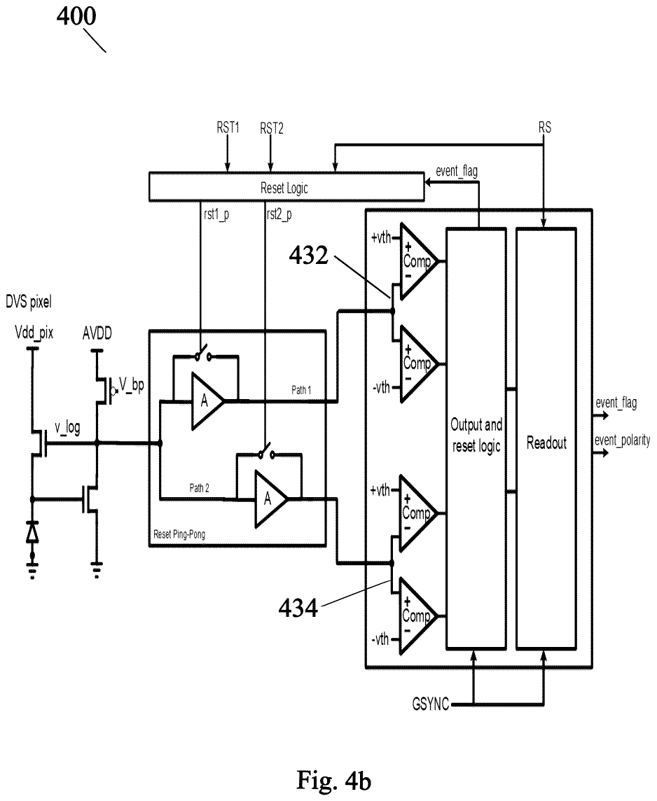

FIG. 4 illustrates a circuit diagram 400 of a ping-pong reset in a dynamic vision sensor pixel. Shown in FIG. 4 is an enhanced DVS (Dynamic Vision Sensor) pixel architecture with dual-path reset logic for improved timing, control, and signal management. The core components of the circuit diagram include a DVS Pixel Core 405, two reset paths 412 two amplifiers 410 each associated with one of the two reset paths, a reset ping-pong block 415, a reset logic block 414, a comparator stage 420, and an output and reset logic and readout block 425.

In one embodiment, the reset ping-pong logic may alternate between two storage nodes so the pixel may have a stable reference for detecting brightness changes, enabling continuous, low-noise, and uninterrupted event generation. According to one embodiment, the photodiode 405 may generate analog signal corresponds to the incident light. The analog signal which is proportional to the incident light is then processed into a logarithm voltage v_log and fed into the two reset paths 412 to be sampled in the reset ping pong block 415. Each reset path includes an associated amplifier 410 which may amplify the logarithmic voltage prior to sending to the reset ping pong block 415.

FIG. 4 shows the refractory-less pixel circuitry, where there are two reset paths 412, path1 and path2. These two paths operate in a ping-pong fashion, where one path is in operation to detect the PD current changes after being reset. The path is in reset means it samples the prior brightness value, when the reset is released, it tracks the brightness change until the change is big enough to make the comparator register an event, while the other one is in reset mode. The Reset Logic uses two reset signals, RST1 and RST2 (which might be combined in one reset signal), and based on the event status bit, event_flag, the reset and detection paths alternate between path1 and path2. This can be explained, as an example, starting from an initial state, and then followed by alternating two phases. In the initial state, path1 and path2 are both in reset to sample v_log, which corresponds to the initial brightness level. Phase one starts when the reset is released in path1 (by deactivating the reset switch using the signal rst1_p, and activating the path1 detection using the signal rst1_n, both signals are generated using the RST1 signal), and path1 starts to operate in the detection mode to track changes in v_log, which corresponds to changes in the brightness level. During phase 1, path2 is still in reset to continuously sample v_log. During phase one, when the brightness level change is big enough relative to the preset threshold vth, the comparator 420 registers an event, and the output and reset logic block activate the event status bit event_flag. The active event_flag is then used with the RST1 and RST2 signals inside the reset logic block, to go from phase one to phase two. Phase two starts by resetting path1 using the signal rst1_p, and releasing the reset in path2 using the signal rst2_p, and deactivating path1 detection mode using the signal rst1_n, and activate the path2 detection mode using signal rst2_n. Phase two continue until the brightness level change is big enough to register another event, which alternate the detection mode to path1 and resets path2. This alternating process between path1 and path2 continues to detect events without refractory period.

FIG. 4b illustrates a circuit diagram of a ping-pong reset in a dynamic vision sensor pixel. FIG. 4b represents another implementation of the ping-pong reset, which follows the same concept, using two extra comparators, so that path1 has its own dedicated comparators, and path2 has its own dedicated comparators. This implementation doesn't need the two control signals rst1_n and rst2_n and eliminates the corresponding transistor switches in path1 and path2. This alternate implementation gives better performance by eliminating the series switches in path1 and path2, at the expense of additional area.

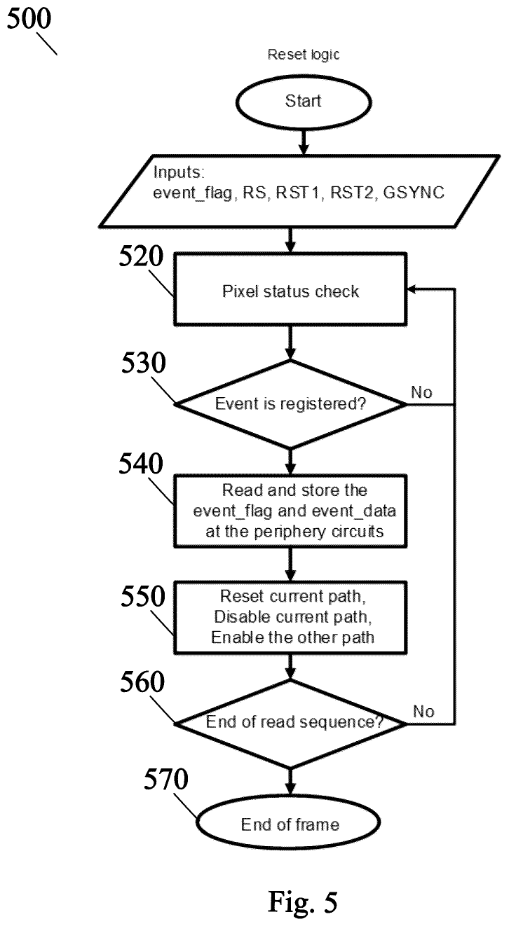

FIG. 5 illustrates a flow chart of ping-pong reset logic in a dynamic vision sensor pixel. As noted above, the Reset Logic uses two reset signals, RST1 and RST2 (which might be combined in one reset signal), and based on the event status bit, event_flag, the reset and detection paths alternate between path1 and path2. The RS signal checks the status of the pixel, and if the event_flag is active, which means the pixel detected an event, the event bits is readout, and the current detection path changes into reset path, while the previous reset path changes into detection path. This method eliminates the refractory period and renders a more linear operation across the pixel array.

The flow chart 500 shown in FIG. 5 receives a plurality of inputs 510 including an event_flag, an RS signal, two reset signals RST1, RST2 and a Global Synchronization signal (GSYNC). A pixel status check 520 may then be performed. Next, a determination if an event has registered may be evaluated 530. If no event is registered the flow returns back to a pixel status check 520. If an event is registered, the pixel may read and store the event_flag and event_data at the periphery circuits 540. After the event_flag and event_data are read at the periphery, the pixel may reset the current path, disable the current path and enable the other path 550. If this is the end of the read sequence 560, the frame ends 570. Otherwise, the flow moves back to a pixel status check 520.

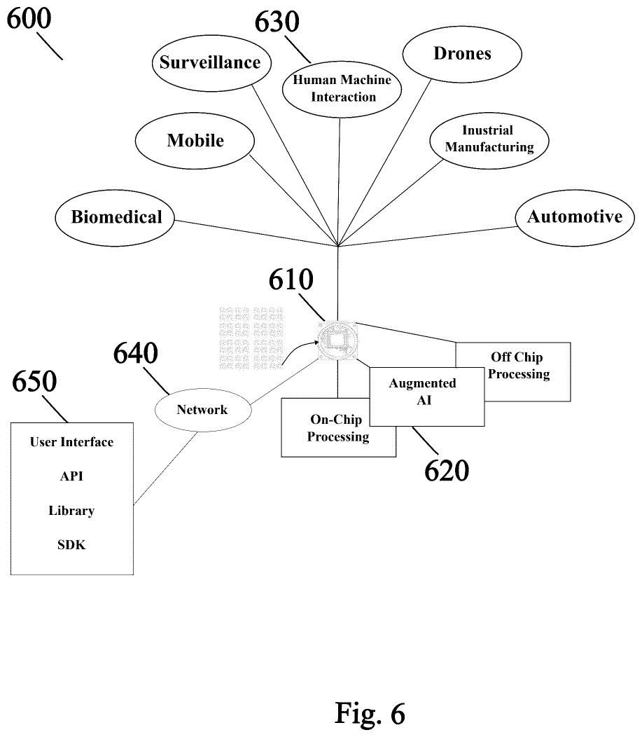

FIG. 6 illustrates a schematic diagram of a vision sensor system according to one embodiment. The vision sensor system 600 depicted in FIG. 6 includes a sensor/array of sensors 610, a suite of processing blocks 620, including on-chip processing, augmented AI and off chip processing. The schematic further includes a network 640 in communication with the sensor/array of sensors and a software stack 650. The software 650 may include a graphical user interface, an Application Programming Interface (API), a software library, and a software development kit (SDK). The software may include modules customized to operate in a set of environment specific applications 630. In one example, the set of environment specific applications may include biomedical, mobile, human machine interaction, industrial/manufacturing, drones and surveillance, among others.

In mobile and embedded imaging applications, event-based vision enables motion-aware reconstruction and stabilization. Continuous temporal sampling allows fine-grained estimation of motion vectors, which can be used to correct blur, track fast-moving features, or reconstruct intensity images with improved sharpness. These capabilities are especially valuable when either the sensor or the observed scene is in motion.

For human-machine interaction, event-driven sensing supports high-precision tracking of eye movements, gestures, and fine motor actions. Because temporal resolution is not constrained by a global frame rate, rapid micro-movements can be detected with minimal latency. This enables responsive interaction in immersive systems and allows detection of high-frequency visual phenomena such as flicker or subtle motion cues across a wide range of illumination levels.

In surveillance contexts, event-based vision enables detection of critical motion patterns—such as falls, intrusions, or abnormal activity—while inherently limiting the capture of identifiable visual detail. Since the sensor reports changes rather than full images, privacy-preserving observation is possible without sacrificing temporal fidelity or responsiveness. Similar advantages apply to crowd analysis, traffic monitoring, and visual odometry, where continuous motion estimation benefits from precise event timing and sparse data representation.

Industrial and manufacturing applications benefit from the ability of event-based sensors to observe motion over an extremely wide temporal bandwidth. The effective temporal resolution corresponds to frame rates on the order of hundreds of thousands to millions of frames per second, enabling analysis of vibrations, oscillations, and transient phenomena that are inaccessible to conventional cameras. This makes the technology well suited for high-speed object counting, particle tracking, conveyor monitoring, and predictive maintenance through vibration analysis.

In drones and robotic systems, event-based vision supports accurate tracking of edges, markers, and structural features in three dimensions. The high temporal precision improves pose estimation and motion prediction, which are critical for closed-loop control in manipulation, navigation, and pick-and-place automation. Continuous event streams allow robots to react to changes in real time rather than waiting for the next image frame.

For automotive and mobility systems, event-driven perception enhances object detection and tracking in challenging conditions, including high relative speeds, rapid lighting transitions, and scenes with extreme contrast. The sensors described herein also lend their advantages to autonomous driving tasks. Event-based sensing also supports real-time monitoring of driver behavior by detecting fine eye and facial movements, enabling rapid assessment of attention and alertness.

In biomedical and scientific applications, the ability to detect microscopic or subtle motion at high temporal resolution enables accelerated analysis of biological processes. Event-based sensors can identify motion signatures that occur on very short time scales, significantly reducing the duration of procedures that rely on visual observation of dynamic samples.

Across these application domains, the unifying technical advantage of event-based vision lies in its asynchronous, data-efficient representation of visual information. By encoding only meaningful temporal changes with precise timing, event-based systems provide high-speed, low-latency perception while minimizing power, bandwidth, and computational overhead compared to traditional frame-based imaging architectures.

While the foregoing invention has been described in some detail for purposes of clarity and understanding, it will be appreciated by one skilled in the art, from a reading of the disclosure, that various changes in form and detail can be made without departing from the true scope of the invention.

1. An image sensing device, comprising:
a digital retina pixel circuit equipped with a photodiode converting a plurality of light signals into a logarithmic voltage signal;
an amplifier amplifying the logarithmic voltage signal for processing at a dual comparator stage, the dual comparator stage including a first positive comparator and a second negative comparator wherein the first positive comparator compares the amplified logarithmic voltage to a positive threshold value and the second negative comparator compares the amplified logarithmic voltage to a negative threshold value;
an output and reset logic stage receiving a positive comparator output and a negative comparator output from the dual comparator stage, the output and reset logic stage generating an event variable;
a readout block generating an event output based on the generated event variable.

2. The image sensing device of claim 1, further comprising:
a pixel disable block deactivating the current paths for the photodiode in the digital retina pixel circuit.

3. The image sensing device of claim 2, further comprising:
an array of digital retina pixel circuits configured in a set of columns and a set of rows.

4. The image sensing device of claim 3, wherein the pixel disable block is configured to deactivate a column in the array of digital retina pixel circuits.

5. The image sensing device of claim 3, wherein the pixel disable block is configured to deactivate a row in the array of digital retina pixel circuits.

6. The image sensing device of claim 3, wherein the pixel disable block is configured to deactivate a region of interest in the array of digital retina pixel circuits.

7. The image sensing device of claim 3, further comprising:
an inertial measurement unit capable of measuring inertial measurement data.

8. The image sensing device of claim 7, wherein the inertial measurement unit includes a plurality of accelerometers and a plurality of gyroscopes.

9. An image sensing device, comprising:
an active pixel sensor including a first digital retina pixel circuit;
a dynamic vision sensor equipped with a second digital retina pixel circuit including a photodiode converting a plurality of light signals into a logarithmic voltage signal;
an amplifier amplifying the logarithmic voltage signal for processing at a dual comparator stage, the dual comparator stage including a first positive comparator and a second negative comparator wherein the first positive comparator compares the amplified logarithmic voltage to a positive threshold value and the second negative comparator compares the amplified logarithmic voltage to a negative threshold value;
an output and reset logic stage receiving a positive comparator output and a negative comparator output from the dual comparator stage, the output and reset logic stage generating an event variable;
a readout block generating an event output based on the generated event variable.

10. The image sensing device of claim 9, further comprising:
a voltage copier buffering the logarithmic voltage signal;
a sampling capacitor receiving a sampled signal based on the buffered logarithmic voltage signal from the voltage copier; and
an analog-to-digital converter converting the sampled signal into a digital signal.

11. The image sensing device of claim 10, further comprising:
an array of active pixel sensors and an array of dynamic vision sensors, the array of active pixel sensors and the array of dynamic vision sensors arranged in a plurality of rows and a plurality of columns.

12. The image sensing device of claim 11, further comprising:
a plurality of analog-to-digital converters associated with each one of the active pixel sensors in the array of active pixel sensors.

13. The image sensing device of claim 11, further comprising:
a plurality of analog-to-digital converters associated with each column in the plurality of columns arranged with the array of active pixel sensors.

14. The image sensing device of claim 8, wherein the analog-to-digital converter generates a multi-bit quantization and a digital signal representation of a magnitude of scene dynamic changes and a corresponding absolute magnitude of a scene brightness and a background light level.

15. The image sensing device of claim 9, further comprising wherein the output and reset logic stage is synchronized with the multi-bit quantization and the digital signal representation of the magnitude of scene dynamic changes and the corresponding absolute magnitude of the scene brightness and the background light level.

16. An image sensing device, comprising:
a dynamic vision sensor equipped with a first digital retina pixel circuit including a photodiode converting a plurality of light signals into a logarithmic voltage signal;
an amplifier amplifying the logarithmic voltage signal for processing at a dual comparator stage, the dual comparator stage including a first positive comparator and a second negative comparator wherein the first positive comparator compares the amplified logarithmic voltage to a positive threshold value and the second negative comparator compares the amplified logarithmic voltage to a negative threshold value;
an output and reset logic stage receiving a positive comparator output and a negative comparator output from the dual comparator stage, the output and reset logic stage generating an event variable;
a readout block generating an event output based on the generated event variable;
a reset logic block processing the event variable and the event output from the output and reset logic stage and the readout block respectively.

17. The image sensing device of claim 16, further comprising:
a reset ping pong stage in communication with the reset logic stage, the reset ping pong stage including a first reset path and a second reset path.

18. The image sensing device of claim 17, wherein the first reset path is initially configured to detect current changes in the photodiode and the second reset path is initially configured in a reset mode.

19. The image sensing device of claim 18, wherein the reset logic alternates configurations of the first reset path and the second reset path based on the event variable and the event output from the output and reset logic stage and the readout block respectively.

20. The image sensing device of claim 18, wherein the dual comparator stage includes a first dual comparator stage in communication with the first reset path and a second dual comparator stage in communication with the second reset path.
